(19) United States
(12) Patent Application Publication
(10) Pub. No.: US 2020/0194962 A1
(43) Pub. Date: Jun. 18, 2020

(54) LASER DEVICE

(71) Applicant: INDUSTRIAL TECHNOLOGY RESEARCH INSTITUTE, Hsinchu (TW)

(72) Inventors: Yao-Wun JHANG, Tainan City (TW); Sheng-Bang HUNG, Chiayi City (TW); Shih-Ting LIN, Tainan City (TW); Yu-Cian SYU, Taoyuan City (TW); Jia-You WANG, Kaohsiung City (TW); Hong-Xi TSAU, Tainan City (TW)

(21) Appl. No.: 16/232,466

(22) Filed: Dec. 26, 2018

(30) Foreign Application Priority Data
Dec. 17, 2018 (TW) 107145379

(51) Int. Cl. H01S 3/30; H01S 3/067; H01S 3/094

(52) U.S. Cl. CPC H01S 3/302; H01S 3/094007; H01S 3/094046; H01S 3/06708

(57) ABSTRACT

A laser device includes a laser seed source, a pump source, a combiner and an optical fiber assembly. The laser seed source is configured to generate a seed laser light. The pump source is configured to generate a pumping laser light. The optical combiner is configured to combine the seed laser light and the pumping laser light and further output the seed laser light and the pumping laser light through an output end. The optical fiber assembly includes a first gain fiber and a first absorbing fiber. The first gain fiber has a first cladding and a first core. The first absorbing fiber has a second cladding and a second core. The second core is connected to the first core of the first gain fiber and configured to absorb a Raman wave signal of the seed laser light. p

### CROSS-REFERENCE TO RELATED APPLICATIONS

This non-provisional application claims priority under 35 U.S.C. § 119(a) on Patent Application No(s). 107145379 filed in Taiwan, R.O.C. on Dec. 17, 2018, the entire contents of which are hereby incorporated by reference.

### BACKGROUND

### 1. Technical Field

This disclosure relates to a laser device having a gain fiber and an absorbing fiber connected.

### 2. Related Art

Recently, the fiber laser is applied widely and has become an indispensable technique in the processing industry. In general, Raman effect may occur when the laser light is transmitted in optical fibers. The Raman effect is an inelastic scattering of a photon, which would result in variations of frequencies of some photons included in an incident light after scattering. Accordingly, the efficiency of the laser is downgraded.

In the recent techniques, the threshold of Raman effect can be raised by shortening the lengths of the optical fibers or enlarging the cross-sectional areas of the optical fibers, so as to reduce interferences of the Raman effect. However, shortening lengths of the optical fibers will cause conditions of poor heat dissipation as well as declining the utilization rate of pump. Enlarging the cross-sectional areas of the optical fibers will cause unnecessary high-order modes resulting in backend energy losses.

It is possible to set up a fiber grating or a band-pass filter for filtering out the Raman waveband. However, on one hand, the band of the band-pass filter is usually too narrow, and multi-stage filtering might be necessary. Accordingly, the cost would be raised a lot. On the other hand, it may not be able to be connected to general fibers by welding. Therefore, it is an important issue how the Raman waveband can be absorbed for suppressing the Raman effect in a low-cost and a high-efficiency way.

### SUMMARY

A laser device is disclosed according to one embodiment of the present disclosure. The laser device comprises a laser seed source, a pump source, an optical combiner and an optical fiber assembly. The laser seed source is configured to generate a seed laser light. The pump source is configured to generate a pumping light. The optical combiner has a receiving end and an outputting end, and the receiving end is connected to the laser seed source and the pump source. The optical combiner is configured to combine the seed laser light and the pumping light so as to output the seed laser light and the pumping light through the outputting end. The optical fiber assembly is connected to the optical combiner. The optical fiber assembly comprises a first gain fiber and a first absorbing fiber. One end of the first gain fiber is connected to the optical combiner, the first gain fiber has a first cladding and a first core, the first cladding of the first gain fiber covers the first core of the first gain fiber, and the first core of the first gain fiber is configured to receive the seed laser light. One end of the first absorbing fiber is connected to the other end of the first gain fiber, the first absorbing fiber has a second cladding and a second core, the second cladding of the first absorbing fiber covers the second core of the first absorbing fiber, the second cladding is connected to the first cladding of the first gain fiber, and the second core of the first absorbing fiber is connected to the first core of the first gain fiber and the second core of the first absorbing fiber is configured to absorb a Raman wave signal of the seed laser light.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a structural diagram of a laser device according to one embodiment of the present disclosure;

FIG. 2 is a perspective view of the optical fiber assembly according to one embodiment of the present disclosure;

FIG. 3 is a structural diagram of a laser device according to another embodiment of the present disclosure; and

FIG. 4 is a waveform of energy according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

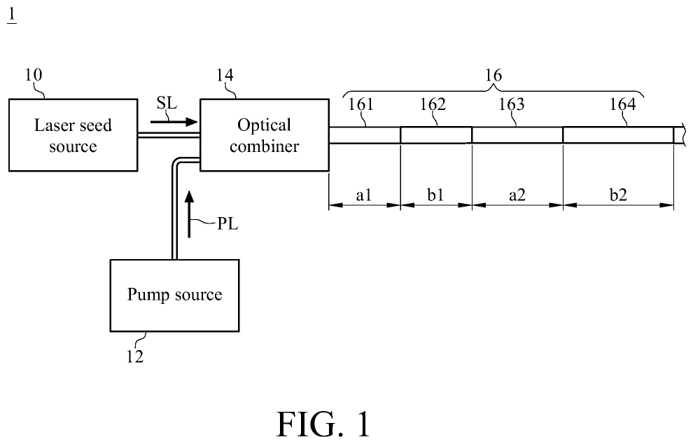

Please refer to FIG. 1, which is a structural diagram of a laser device 1 according to one embodiment of the present disclosure. As shown in FIG. 1, a laser device 1 includes a laser seed source 10, a pump source 12 an optical combiner 14 and an optical fiber assembly 16. The laser seed source 10 is configured to generate a seed laser light SL while the pump source 12 is configured to generate a pumping light PL. In an embodiment, an outputting waveband of the laser seed source 10 is within a range of 1020 (nm) to 1080 (nm), and an outputting waveband of the pump source 12 is within a range of 900 (nm) to 985 (nm). The optical combiner 14 has a receiving end and an outputting end (not labelled in the figure). The receiving end of the optical combiner 14 is connected to the laser seed source 10 and the pump source 12, and the outputting end of the optical combiner 14 is connected to the optical fiber assembly 16. Specifically, the optical combiner 14 is connected to the laser seed source 10 and the pump source 12 through respective optical fibers for receiving the seed laser light SL and the pumping light PL. The optical combiner 14 further combines the seed laser light SL and the pumping light PL and outputs the seed laser light SL and the pumping light PL through the outputting end.

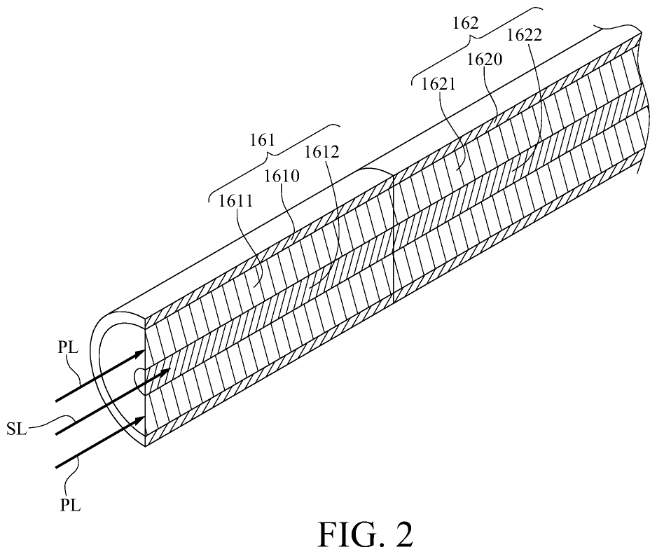

Please further refer to FIG. 2, which is a perspective view of the optical fiber assembly 16 according to one embodiment of the present disclosure. As shown in FIG. 1 and FIG. 2, the optical fiber assembly 16 includes a gain fiber 161 and an absorbing fiber 162. One end of the gain fiber 161 is connected to the optical combiner 14 and the other end of the gain fiber 161 is connected to the absorbing fiber 162. The gain fiber 161 has a cladding 1611 and a core 1612, and the core 1612 is covered by the cladding 1611. Similarly, the absorbing fiber 162 has a cladding 1621 and a core 1622, and the core 1622 is covered by the cladding 1621. In more detail, as shown in FIG. 2, the cladding 1611 of the gain fiber 161 is connected to the cladding 1621 of the absorbing fiber 162, and the core 1612 of the gain fiber 161 is connected to the core 1622 of the absorbing fiber 162. In practice, the gain fiber 161 further has a coating 1610 covering the cladding 1611, and the absorbing fiber 162 further has a coating 1620 covering the cladding 1621, wherein the coating 1610 and the coating 1620 both are used for providing a physical protection so as to prevent the inner claddings or cores from being damaged.

In the embodiments of FIG. 1 and FIG. 2, the core 1612 of the gain fiber 161 is configured to receive the laser light SL outputted from the outputting end of the optical combiner 14, and the core 1612 further transmits the seed laser light SL to the core 1622 of the absorbing fiber 162. Such that the core 1622 of the absorbing fiber 162 absorbs a Raman wave signal of the seed laser light SL. That is, the absorbing fiber 162 is capable of absorbing the Raman spectra which is approximately within a range of 1090 (nm) to 1300 (nm). As a result, the interference of Raman effect is reduced and accordingly the outputting efficiency of the laser device is improved. In one embodiment, the cladding 1611 of the gain fiber 161 is configured to receive energy of the pumping light PL, and the gain fiber 161 enhances energy of the seed laser light SL by absorbing the energy of the pumping light PL. More specifically, when the seed laser light SL is transmitted from the laser seed source 10 to the core 1612 of the gain fiber 161, the pumping light PL is transmitted from the pump source 12 to the cladding 1611 of the gain fiber 161. In the process of the transmission, the gain fiber 161 is capable of enhancing the energy of the seed laser light SL by absorbing the energy of the pumping light PL. That is, the energy of the pumping light PL is transmitted from the cladding 1611 to the core 1612.

In one embodiment, the gain fiber 161 is a ytterbium-doped optical fiber, wherein the core 1612 is doped with ytterbium element, but the cladding 1611 is not doped with ytterbium element. The absorbing fiber 162 is a thulium-doped fiber, a holmium-doped or a fiber with a mixing ratio between thulium-doped and holmium-doped, wherein the core 1622 is doped with thulium and/or holmium elements, but the cladding 1621 is not doped with Thulium and/or holmium element. In one embodiment, the absorbing fiber 162 is mainly used for absorbing the wavelength of Raman effect. Although different seed light sources have different wavelengths of Raman effect, the wavelength to be absorbed is approximately within the range of 1090 (nm) to 1300 (nm). In practice, the mixing ratio can be adjusted according to actual demands. The materials of the gain fiber and the absorbing fiber mentioned in the above embodiment are merely for illustration, and the present disclosure is not limited to the above embodiment. In the embodiment of FIG. 2, a diameter of a cross-sectional area of the core 1612 in the gain fiber 161 is identical to a diameter of a cross-sectional area of the core 1622 in the absorbing fiber 162. In another embodiment, a ratio of the diameter of the cross-sectional area of the core 1612 in the gain fiber 161 and the diameter of the cross-sectional area of the core 1622 in the absorbing fiber 162 is within a range of 0.9 to 1.1, but the present disclosure is not limited to the above embodiment. For example, if the cross-sectional area of the core 1621 in the gain fiber 161 has the diameter of R, the cross-sectional area of the core 1622 in the absorbing fiber 162 has the diameter within the range of 0.9*R to 1.1*R. In another embodiment, if the cross-sectional area of the core 1622 in the absorbing fiber 162 has the diameter of R, the cross-sectional area of the core 1621 of the gain fiber 161 has the diameter within the range of 0.9*R to 1.1*R.

In other words, the difference between the diameter of the cross-sectional area of the core 1621 in the gain fiber 161 and the diameter of the cross-sectional area of the core 1622 in the absorbing fiber 162 is within 10%. In practice, the gain fiber 161 and the absorbing fiber 162 can be connected by welding. With the difference between the diameter of the cross-sectional area of the core 1612 in the gain fiber 161 and the diameter of the cross-sectional area of the core 1622 in the absorbing fiber 162 within 10%, the connection between two fibers is improved and accordingly the stability of transmission of the seed laser light SL is raised.

In one embodiment, as shown in FIG. 1, the optical fiber assembly 16 further includes a gain fiber 163 and an absorbing fiber 164. One end of the gain fiber 163 is connected to the other end of the absorbing fiber 162, and the other end of the gain fiber 163 is connected to the absorbing fiber 164. The gain fiber 163 and the absorbing fiber 164 have similar structures to the gain fiber 161 and the absorbing fiber 162 respectively as shown in FIG. 2. That is, each of the gain fiber 163 and the absorbing fiber 164 has a cladding and a core (not shown in figures). The cladding of the gain fiber 163 is connected to the cladding of the absorbing fiber 164, and the core of the gain fiber 163 is connected to the core of the absorbing fiber 164. More specifically, the claddings of all gain/absorbing fibers are connected together to provide a channel for transmitting the pumping light PL, and the cores of all gain/absorbing fibers are connected together to provide a channel for transmitting the seed laser light SL.

In practice, the laser seed source 10, generating the seed laser light SL, enters the core 1611 of the gain fiber 161 via one end of the gain fiber 161. The Raman scattering may occur when the seed laser light SL reaches a position at a certain length of the gain fiber 161. With the absorbing fiber 162 connected to the other end of the gain fiber 161, the Raman wave signal of the seed laser light SL is absorbed properly to suppress Raman effect. Then, the seed laser light SL, processed by the absorbing fiber 162, is transmitted to the gain fiber 163. Similarly, the Raman scattering may occur again when the laser light SL reaches a position at a certain length of the gain fiber 163. With the absorbing fiber 164 connected to the other end of the gain fiber 163, the Raman wave signal of the seed laser light SL is absorbed properly to suppress Raman effect.

In one embodiment, as shown in FIG. 1, a length b2 of the absorbing fiber 164 is greater than a length b1 of the absorbing fiber 162 (that is, b2>b1). However, in another embodiment, the length b2 of the absorbing fiber 164 is identical to the length b1 of the absorbing fiber 162 (that is, b2=b1). In one embodiment, a sum of the length a2 of the gain fiber 163 and the length b2 of the absorbing fiber 164 is greater than a sum of the length a1 of the gain fiber 161 and the length b1 of the absorbing fiber 162, (that is, (a2+b2)>(a1+b1)). However, in another embodiment, the sum of the length a2 of the gain fiber 163 and the length b2 of the absorbing fiber 164 is identical to the sum of the length a1 of the gain fiber 161 and the length b1 of the absorbing fiber 162 (that is, (a2+b2)=(a1+b1)).

In an experimental example, the length a1 of the gain fiber 161 is 4 m, the length b1 of the absorbing fiber 162 is 2 m, the length a2 of the gain fiber 163 is 4.2 m, and the length b2 of the gain fiber 164 is 3 m. However, the present disclosure is not limited to the experimental example. In practice, referring to the following formula (1), the sum of the lengths of the gain fiber 161 and the absorbing fiber 162 (a1+b1) is defined as a critical length, in which the Raman effect occurs, and the critical length is identical to L_{eff}. Since the thresholds of the Raman effect are different, the length sum (a1+b1) is different from the length sum (a2+b2). For example, the length sum (a2+b2) is greater than the length sum (a1+b1), wherein the length sum (a1+b1) and the length sum (a2+b2) can be selected based on a range of 3 m to 8 m. Therefore, a non-linear effect occurs if the fiber lengths are (a1+b1) and (a2+b2), and the non-linear wavelengths can be absorbed by the absorbing fiber 162 and the absorbing fiber 164.

P_{SRS}≈≠·A_{eff}/L_{eff}g_{R} formula (1), wherein P_{SRS} stands for a threshold of Raman effect, g_{R} stands for a Raman-gain coefficient, A_{eff} stands for an effective cross-sectional area, and L_{eff} stands for an effective interaction length.

In one embodiment, the optical fiber assembly 16 of the laser device 1 has the plurality of gain fibers and the plurality of absorbing fibers, with the number of the gain fibers is identical to the number of the absorbing fibers. That is, the gain fibers and the absorbing fibers are arranged in pairs. Each of the gain fibers is connected to a respective one of the absorbing fibers, so that the Raman wave signals (the waveband of Raman effect) of the seed laser light are absorbed by the absorbing fibers when the Raman effect occurs in the process of the transmission of the seed laser light.

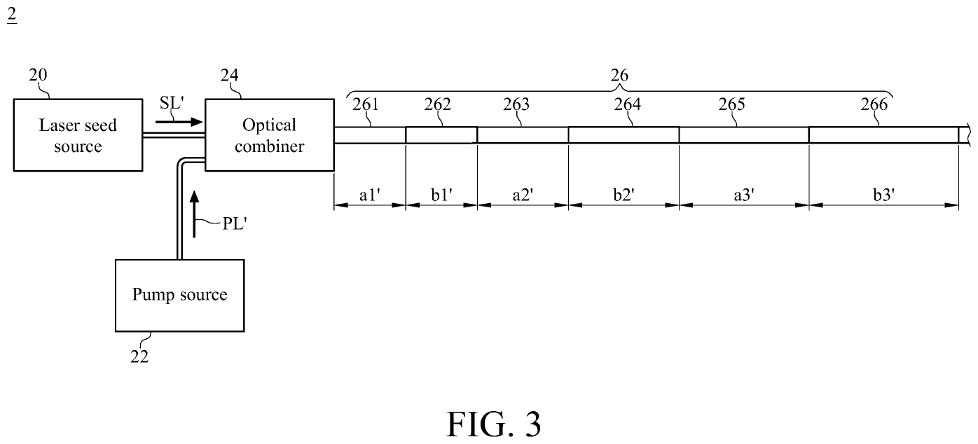

In one embodiment, in the optical fiber assembly 16 of the laser device 1, the maximum number of the gain fibers or the maximum number of absorbing fibers is 3. Please refer to FIG. 3, which is a diagram of a laser device 2 according to another embodiment of the present disclosure. The structure of FIG. 3 is similar to the structure of FIG. 1. In FIG. 3, the laser device 2 includes a laser seed source 20, a pump source 22, an optical combiner 24 and an optical fiber assembly 26. In FIG. 3, the laser seed source 20 and the pump source 22 of the laser device 2 are configured to generate a seed laser light SL′ and a pumping light PL′ respectively. And the seed laser light SL′ and the pumping light PL′ are further provided to the optical combiner 24. The difference between FIG. 3 and FIG. 1 lies in that the optical fiber assembly 26 further includes the gain fiber 265 and the absorbing fiber 266. The gain fibers 261 (length a1′) and 263 (length a2′) as well as the absorbing fibers 262 (length b1 ‘) and 264 (length b2’) still remain. That is, the three gain fibers and the three absorbing fibers are connected in a staggered manner. If the third gain fiber 265 has a length a3′ and the absorbing fiber 266 has a length b3′, the length relationship of the optical fiber assembly 26 indicates (a1′+b1′)≤(a2′+b2′)≤(a3′+b3′). If the number of the gain fibers and the number of the absorbing fibers are too large, the overall length of the transmission optical fiber consisting of the gain fibers and the absorbing fibers would be too long accordingly, which results in an unstable output of the laser light. Therefore, the number of the gain fibers and the number of the absorbing fibers are limited herein.

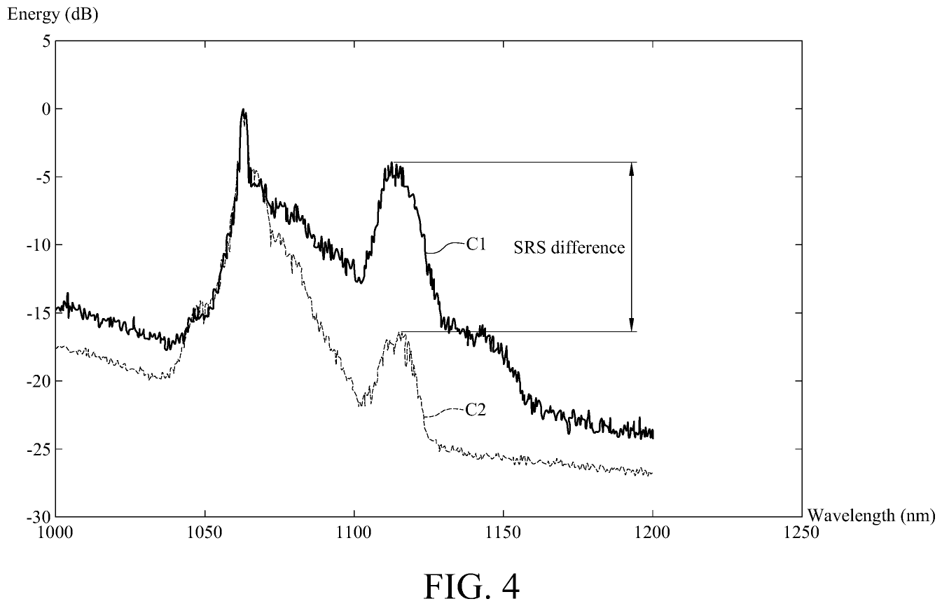

Please refer to FIG. 4, which is a waveform of energy according to one embodiment of the present disclosure. In FIG. 4, a curve C1 indicates a variation of energy of a comparative laser device while a curve C2 indicates a variation of energy of the laser device in the present disclosure. As shown in FIG. 4, the energy in the range of wavelength of 1100-1150 (nm) shown in the curve C2 is significantly lower than the energy in the range of wavelength of 1100-1150 (nm) shown in the curve C1. It is verified that the effect of Raman scattering occurring in the laser device of the present disclosure is significantly less than in the comparative laser device. Since the stagger arrangement of the gain fibers and absorbing fibers is included in the laser device of the present disclosure, the waveband of Raman effect is absorbed properly. Therefore, in a condition that the same output power is provided, the Raman effect is suppressed effectively in the laser device of the present disclosure. Regarding the improvement of suppressing the stimulated Raman Scattering (SRS), as shown in FIG. 4, the SRS reduction is approximately 20 dB. A better outputting efficiency of laser (10%-20% increased) is obtained when a high-peak power is transmitted, and the pump leakage is significantly reduced and the stability of the laser system is improved.

In view of the above description, the gain fiber and the absorbing fiber in the laser device of the present disclosure are connected together, so the Raman wave signal of the seed laser light can be absorbed by the absorbing fiber when the non-linear Raman effect occurs. Accordingly, the Raman effect can be suppressed and the laser device is capable of outputting a laser with high-quality and pure signals for improving the outputting efficiency of laser. Therefore, the pump leakage is reduced significantly and the overall stability of the laser device is improved.

1. A laser device, comprising:
a laser seed source configured to generate a seed laser light;
a pump source configured to generate a pumping light;
an optical combiner having a receiving end and an outputting end, the receiving end being connected to the laser seed source and the pump source, the optical combiner configured to combine the seed laser light and the pumping light so as to output the seed laser light and the pumping light through the outputting end; and
an optical fiber assembly connected to the optical combiner, the optical fiber assembly comprising:
a first gain fiber, one end of the first gain fiber connected to the optical combiner, the first gain fiber having a first cladding and a first core, the first cladding of the first gain fiber covering the first core of the first gain fiber, the first core of the first gain fiber doped with gain material and configured to receive the seed laser light, and the first cladding of the first gain fiber not doped with gain material; and
a first absorbing fiber, one end of the first absorbing fiber connected to another end of the first gain fiber, the first absorbing fiber having a second cladding and a second core, the second cladding of the first absorbing fiber covering the second core of the first absorbing fiber, the second cladding connected to the first cladding of the first gain fiber, the second core of the first absorbing fiber connected to the first core of the first gain fiber, the second core of the first absorbing fiber doped with absorbing material and configured to absorb a Raman wave signal of the seed laser light, and the second cladding of the first absorbing fiber not doped with absorbing material.

2. The laser device according to claim 1, wherein the optical fiber assembly further comprises a second gain fiber and a second absorbing fiber, one end of the second gain fiber is connected to the other end of the first absorbing fiber, and the other end of the second gain fiber is connected to the second absorbing fiber.

3. The laser device according to claim 2, wherein a length of the second absorbing fiber is greater than or equal to a length of the first absorbing fiber.

4. The laser device according to claim 2, wherein a sum of a length of the second gain fiber and a length of the second absorbing fiber is greater than or equal to a sum of a length of the first gain fiber and a length of the first absorbing fiber.

5. The laser device according to claim 1, wherein the optical fiber assembly further comprises one or more second gain fibers and one or more second absorbing fibers, the one or more second gain fibers and the one or more second absorbing fibers are connected in a staggered manner, and the number of the one or more second gain fibers and the number of the one or more second absorbing fibers both are not greater than two.

6. The laser device according to claim 1, wherein the optical fiber assembly further comprises one or more second gain fibers and one or more second absorbing fibers, and the number of the one or more second gain fibers is identical to the number of the one or more second absorbing fibers.

7. The laser device according to claim 1, wherein a ratio of a cross-sectional diameter of the first core of the first gain fiber to a cross-sectional diameter of the second core of the first absorbing fiber is within a range of 0.9 to 1.1.

8. The laser device according to claim 1, wherein the first gain fiber is a Ytterbium-doped fiber, with the first core of the first gain fiber doped with Ytterbium, and the first absorbing fiber is a Thulium-doped fiber, a Holmium-doped fiber or a fiber with a mixing ratio between the Thulium-doped fiber and the Holmium-doped fiber, with the second core of the first absorbing fiber doped with Thulium, Holmium, or a combination of Thulium and Holmium.

9. The laser device according to claim 1, wherein the first cladding of the first gain fiber is configured to receive energy of the pumping light, and the first gain fiber enhances energy of the seed laser light by absorbing the energy of the pumping light.
